(19) United States
(12) Patent Application Publication
(10) Pub. No.: US 2017/0303714 A1
(43) Pub. Date: Oct. 26, 2017

(54) COOKIE HOLDER

(71) Applicant: William Jefferson McSorley, Glendale, MO (US)

(72) Inventor: William Jefferson McSorley, Glendale, MO (US)

(21) Appl. No.: 15/136,919

(22) Filed: Apr. 23, 2016

(51) Int. Cl. A47G 19/30; F16M 13/02; A47G 23/00

(52) U.S. Cl. CPC A47G 19/30; A47G 23/00; F16M 13/02

(57) ABSTRACT

The cookie holder is a single molded plastic device that has an elongated cup shape at the top and a shaft shaped base that extending down from the cup. The walls of the cup shape have open sides on the elongated ends and a small flap in what is the front of the cup and a larger flap in the back of the cup, that provides an open top of the cup shape, in which a single cookie can be partially inserted, for holding a cookie in an upright position. The design and shape of the cookie holder allows the front surface of the cookie to be viewed in an upright position. The cookie holder can be used by itself or with multiple cookie holders to make a display or arrangement for sale or marketing purposes.

### REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

For the commercial sale and marketing of gourmet, decorated, or home-style cookies, there are limited ways to present them for display and merchandising. When presenting or marketing these cookies for sale, it is important to see the front surface of the cookie. Especially if it is a decorated cookie. Seeing the front surface of many types of cookies is also relevant for visually identifying ingredients and for its visual appeal to a persons' appetite. Visually seeing the front of the cookie is also important in the selling and merchandising of any cookie that is not recognized by a trade name.

For the sale and marketing of gourmet, decorative, home-style, or commercially-made cookies, there are limited methods of displaying them individually, in an arrangement, or on display that show the front of the cookies.

Specifically, there are limited ways to present cookies in an upright/vertical position and show the front of the cookie. An existing method is to bake/make the cookie with a “stick” in it, for upright display. This method is used with multiple cookies on sticks for making displays or arrangements. These cookies on sticks can be arranged with other non-edible items such as gift items, colored tissue, and decorative items to enhance the arrangement.

This stick process limits the type of cookie ingredients that can be used. Most types of cookie ingredients cannot use this method because the cookie will fall apart, not stay on the stick, or the overall size and thickness of a cookie is not conducive to have a stick through it.

### BRIEF SUMMARY OF THE INVENTION

The cookie holder is a single molded plastic device that has an elongated cup shape at the top and a shaft shaped base that extending down from the cup. The walls of the cup shape have open sides on the elongated ends and a small flap in what is the front of the cup and a larger flap in the back of the cup. This design provides an open top of the cup shape, in which a cookie can be partially inserted, for holding a cookie in an upright position.

The cookie holder is designed to hold any type of cookie, regardless of ingredients, in an upright position, that allows the majority of the front surface of the cookie to be viewed. The cookie holder is designed to hold a single cookie, by placing the lower portion of the cookie's edge within the base of the cup, between the front and back flap of the cup.

The cookie holder provides a method of displaying any single cookie by itself, or when multiple cookie holders are used together in upright/vertical positions, they can be used to make an arrangement or display. This method would allow the observation of the cookie's front surfaces, to view decorated surface(s) or ingredient(s) of the cookies.

The cookie holder expands the ability to market and sell any type of cookie individually, in arrangements, and gift displays.

### BRIEF DESCRIPTION OF THE SEVERAL VIEWS OF THE DRAWING

FIG. 1 is a perspective view of a cookie holder with broken line of a cookie to show usage;

FIG. 2 is a front elevational view of FIG. 1;

FIG. 3 is a back elevational view of FIG. 1;

FIG. 4 is a left elevational view of FIG. 1;

FIG. 5 is a right elevational view of FIG. 1;

FIG. 6 is a top plan view of FIG. 1;

FIG. 7 is a bottom plan view of FIG. 1;

FIG. 8 is a perspective close up view of the notches on the back side of the shaft of FIG. 1; and

FIG. 9 is an example of a perspective view of multiple cookie holders used in arrangement thereof.

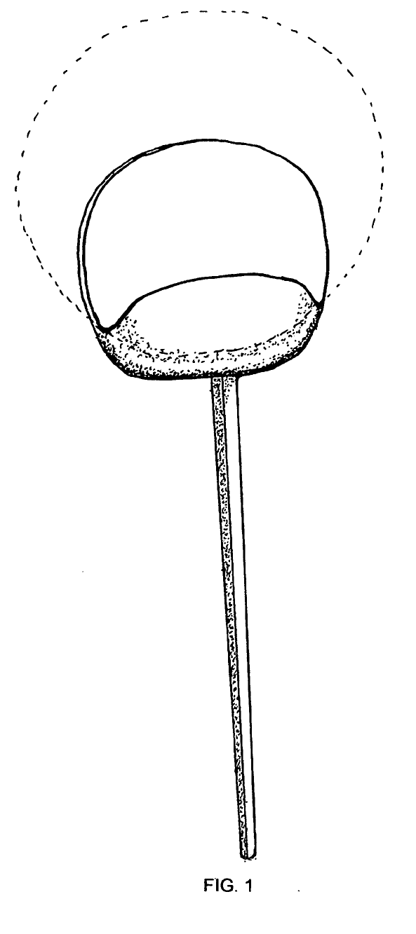

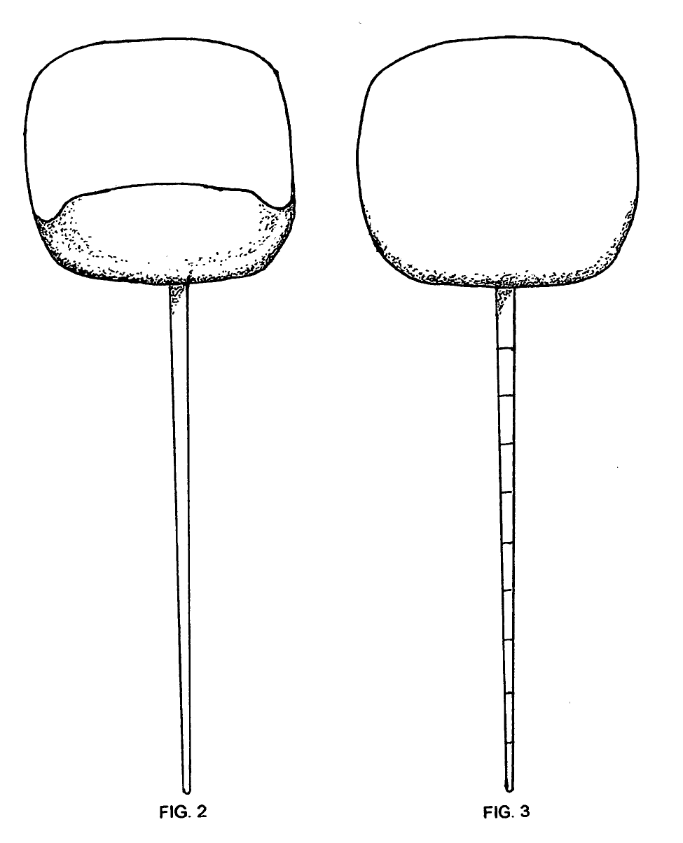

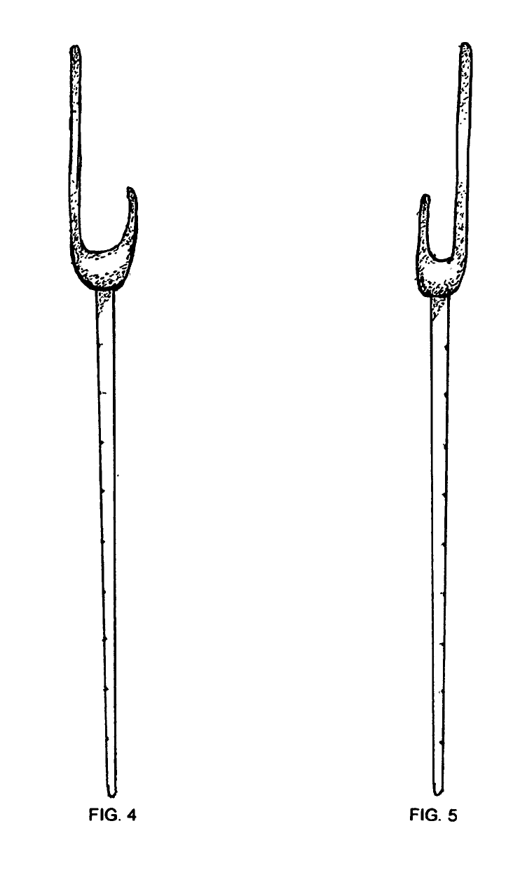

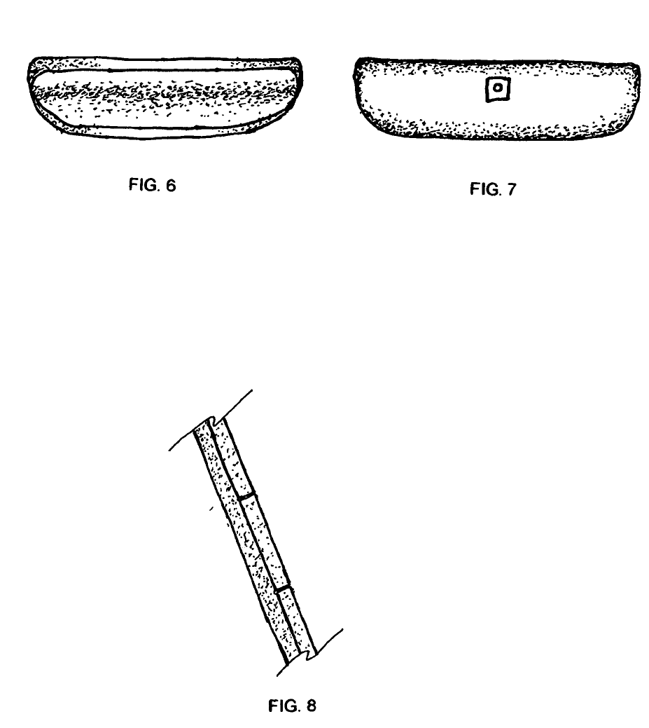

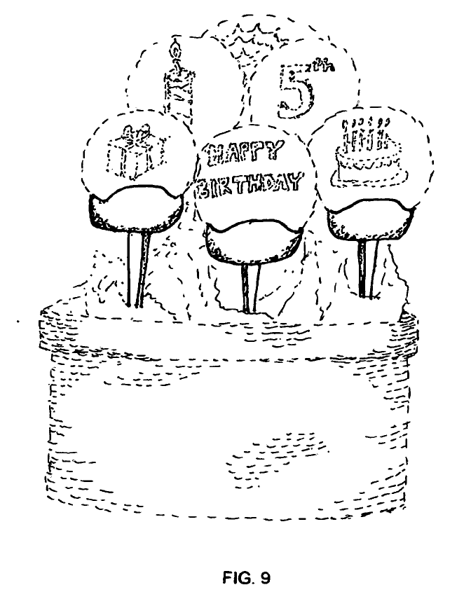

### DETAILED DESCRIPTION OF THE INVENTION

The cookie holder is a single molded piece of plastic that has a cup shape at the top and a shaft extending down from the cup. The cookie holder will be made in an injected mold process. The plastic used is a “food-safe” plastic. The cookie holder can be made in a variety of colored plastics. The variety of colors will allow coordinating the colored cookie holder(s) for use with various holidays, themed events, and occasions. In example: Orange and Black for Halloween. Red, White, and Blue for the 4^{th} of July.

The overall height of the cookie holder is 12 inches from top to bottom.

The form of the cup area has rounded surfaces and oval shapes in its design. The cup section of the cookie holder is 3 inches in width across the front, the back flap section is 2-1/2 inches high from the base of the cup to its top edge, the front flap is 1 inch high from the base of the cup to its top edge, and the depth of the cup is 0.75 inch from the front surface of the cup to the back surface of the cup. The front and back flap sections are each 0.125 inches thick. This provides a 0.50 inch space between the front and back flaps for inserting a cookie.

The shaft part of the cookie holder is centered on the bottom of the cup and extends down 9-1/2 inches long. It is square in shape with one of the flat surfaces to the front of the cookie holder. The top section of the shaft closest to the cup is 0.25 inches square in shape and tappers to 0.125 inch square in shape at the bottom.

The shaft of the cookie holder can be cut to various lengths for providing different heights in an arrangement or display. The back side of the shaft has horizontal notches on the flat surface spaced every 1 inch from the top of the shaft to the bottom of the shaft. These notches are 0.03125 deep into back surface of the shaft. These are used as guides for cutting the shaft.

For use of the cookie holder, take a single cookie, and insert an edge of the cookie into the top open cup area of the cookie holder, between the front flap and the back flap. Press the cookie down into the cookie holder until it reaches the bottom of the cup area or is secure enough to hold in place. This can be done directly into the cookie holder (food-safe plastic). An alternative method, the cookie could be partially wrapped on the bottom edge with a food-safe tissue before inserting into the cookie holder. This can be done for a decorative effect.

The cookie holder's shaft portion can be inserted into materials to hold it in place in an upright position. In example, the shaft can be inserted into Styrofoam. The square edges of the shaft prevent the cookie holder from rotating or twisting when inserted into firm materials. The cookie holder can be used with other cookie holders to make an arrangement or display.

Example to make a Cookie Arrangement. A bowl, pot, or basket, can used as a base container. A piece of Styrofoam can be placed in the container. The shafts of the cookie holders can be inserted into the Styrofoam in an upright arrangement. Cookies can then be inserted into the cookie holders. Food-safe tissue or other decorative materials can be added around the base of the cookie shafts for a decorative effect.

What is claimed is:

1. The cookie holder is a device comprising of a single molded piece of plastic that has an elongated cup shape at the top and a shaft shaped base that extending down from the cup.

2. The cookie holder of claim 1, wherein will be made in an injected mold process.

3. The cookie holder of claim 1, wherein the plastic used to make the device is a food-safe plastic.

4. The cookie holder of claim 1, wherein can be made in a variety of colored plastics.

5. The cookie holder of claim 4, wherein the variety of colors will allow coordinating the colored cookie holder(s) for use with various holidays, themed events, and occasions.

6. The cookie holder of claim 5, wherein example: Orange and Black for Halloween or Red, White, and Blue for the 4^{th} of July.

7. The cookie holder of claim 1, wherein has an overall height of 12 inches from top to bottom.

8. The cookie holder of claim 1, wherein the cup area has the form of rounded surfaces and oval shapes in its design.

9. The cookie holder of claim 8, wherein the cup section of the cookie holder is 3 inches in width across the front.

10. The cookie holder of claim 8, wherein the back section is 2-1/2 inches high from the base of the cup to its top edge.

11. The cookie holder of claim 8, wherein the front section is 1 inch high from the base of the cup to its top edge.

12. The cookie holder of claim 8, wherein the depth of the cup is 0.75 inch from the front surface of the cup to the back surface of the cup.

13. The cookie holder of claim 8, wherein the front and back sections are each 0.125 inches thick.

14. The cookie holder of claim 8, wherein the space between the front and back section provides a 0.50 inch space between the front and back flaps for inserting a cookie.

15. The cookie holder of claim 1, wherein the shaft portion of the cookie holder is centered on the bottom of the cup and extends down 9-1/2 inches long.

16. The cookie holder of claim 15, wherein the shaft has four flat sides in shape with one of the flat surfaces to the front of the cookie holder.

17. The cookie holder of claim 15, wherein the top section of the shaft closest to the cup is 0.25 inches in width and tapers to 0.125 inch in width at the bottom.

18. The cookie holder of claim 15, wherein the shaft of the cookie holder can be cut to various lengths for providing different heights in an arrangement or display.

19. The cookie holder of claim 15, wherein the back side of the shaft has horizontal notches on the flat surface ever spaced every 1 inch from the top of the shaft to the bottom of the shaft.

20. The cookie holder of claim 19, wherein these notches are 0.03125 deep into back surface of the shaft.

21. The cookie holder of claim 19, wherein these are used as guides for cutting the shaft at specific lengths.

22. The cookie holder of claim 1, wherein for the use of the cookie holder, take a single cookie and insert an edge of the cookie into the top open cup area of the cookie holder, between the front surface and the back surface.

23. The cookie holder of claim 22, wherein press the cookie down into the cookie holder until it reaches the bottom of the cup area or is secure enough to hold in place.

24. The cookie holder of claim 22, wherein this can be done directly into the cookie holder (food-safe plastic).

25. The cookie holder of claim 22, the cookie can be partially wrapped on the bottom edge with a food-safe tissue before inserting in to the cookie holder. This can be done for a decorative effect.

26. The cookie holder of claim 1, wherein the cookie holder's shaft portion can be inserted into materials to hold it in place in an upright position.

27. The cookie holder of claim 26, wherein example, the shaft can be inserted into Styrofoam.

28. The cookie holder of claim 26, wherein the square edges of the shaft prevent the cookie holder from rotating or twisting when inserted into firm materials.

29. The cookie holder of claim 26, wherein the cookie holder can be used with other cookie holders to make an arrangement or display.

30. The cookie holder of claim 1, wherein can be used to make a Cookie Arrangement.

31. The cookie holder of claim 30, wherein a bowl, pot, or basket, can used as a base container.

32. The cookie holder of claim 30, wherein a piece of Styrofoam can be placed in the container.

33. The cookie holder of claim 30, wherein the shafts of the cookie holders can be inserted into the Styrofoam in an upright arrangement.

34. The cookie holder of claim 30, wherein cookies can then be inserted into the cookie holders.

35. The cookie holder of claim 30, wherein food-safe tissue or other decorative materials can be added around the base of the cookie shafts for a decorative effect.
